(19) United States
(12) Patent Application Publication
(10) Pub. No.: US 2010/0330999 A1
(43) Pub. Date: Dec. 30, 2010

(54) Handover Support in Radio Communications

(75) Inventors: Daniel Larsson, Solna (SE); Walter Müller, Upplands Vasby (SE)

Correspondence Address: POTOMAC PATENT GROUP PLLC, P. O. BOX 270, FREDERICKSBURG, VA, 22404, US

(73) Assignee: TELEFONAKTIEBOLAGET L M ERICSSSON (PUBL), Stockholm (SE)

(21) Appl. No.: 12/494,581

(22) Filed: Jun. 30, 2009

Related U.S. Application Data
(63) Continuation of application No. PCT/SE2009/050814, filed on Jun. 25, 2009.

(51) Int. Cl. H04W 36/00

(52) U.S. Cl. 455/439

(57) ABSTRACT

User equipment is to be handed over from a source cell to a target cell in a radio communication network. The user equipment is assigned dedicated uplink resources in the source cell, and a handover candidate cell is prepared for receiving the user equipment by obtaining information about the assigned dedicated uplink resources in the source cell. A radio base station for the handover candidate cell is listening for user equipment transmissions and determines, when receiving a user equipment transmission, whether the received user equipment transmission can be detected based on information about the assigned dedicated uplink resources in the source cell in order to assess if the received user equipment transmission is coming from user equipment for which the handover candidate cell has been prepared. The radio base station for the handover candidate cell initiates a handover procedure for the user equipment if it is assessed that the received user equipment transmission is coming from user equipment for which the handover candidate cell has been prepared. In this way, handover can be initiated and completed even if the serving radio base station of the source cell cannot receive a handover-triggering measurement report from the UE.

### TECHNICAL FIELD

The invention generally relates to radio communications technology and more particularly to handover and support for reliable handover in radio communication networks.

### BACKGROUND

A fundamental feature in a cellular radio communication network is handover (HO). Handover is a main function that is used to support mobility in the network. When user equipment (UE) is moving in the cellular network, it has to change serving cell when the signal from the current cell is too weak to support the current radio link and/or when it is decided that another cell has better possibilities to support the radio communication.

In Wideband Code Division Multiple Access (WCDMA) systems, for example, there is soft handover (SHO) functionality. This means that there may exist several radio links between the user terminal and the network. This has the effect that the combination of several radio links may together provide sufficient quality of the combined radio link set.

In Long Term Evolution (LTE), for example, all cells should be able to use the same carrier frequency and a UE typically uses only one serving cell at a time. Hence it is of major importance that the UE stays connected to the best suitable serving cell at all times especially for delay sensitive services.

This means that UE performance for cell search, cell detection as well as efficient neighbour cell measurements is important. Since LTE is based on mobile assisted network-controlled handover, e.g. when the serving eNodeB (eNB) controlling the serving cell takes initiative, typically in response to receiving a measurement report sent from the UE, to prepare and execute and complete the handover, it is of major importance that the information collected by the UE and transmitted to the serving eNB for selecting the best cell actually reaches the serving eNB and that handover signaling is successful.

As an option in LTE, several cells beside the intended target cell can be prepared for receiving the UE. At preparation the cell(s) to be prepared obtain information about current UE configuration and UE identities and information that makes it possible to route information back to the source cell. The decision as to which cells that should be prepared for receiving the UE may also be based on measurement reports from the UE but typically triggered before the actual handover is needed.

In LTE, the Reference Signal Received Power (RSRP) and/or Reference Signal Received Quality (RSRQ) or equivalent signal quality measure is then measured downlink by the UE and sent to eNB for the actual handover evaluation, i.e. the UE measures for example RSRP and/or RSRQ on the serving cell as well as on detected (by cell search) neighbouring cells.

The UE then provides the measurement results to the serving eNB by sending a so-called handover measurement report to the serving eNB either periodical or event triggered or event triggered periodic. The result includes measurement identity and cell identities of the cells fulfilling conditions set by the network as well as the result of for example the RSRP and/or RSRQ measurements for each of the cells.

As can be understood it is essential for the serving eNB to be able to receive these measurement reports in order for the serving eNB to evaluate and take decisions to start preparing and executing the handover. In 3GPP, for example, there have been concerns that the handover mechanism does not provide for reliable handover to a new target cell when needed. A problem is that the measurement report(s) may not be received by the source cell and hence handover to a new target cell will not be initiated.

### SUMMARY

It is a general object to provide efficient support for reliable handover of user equipment from a source cell to a target cell in a radio communication network.

It is a specific object to provide a method for supporting handover in a radio communication network.

It is another specific object to provide an apparatus for supporting handover in a radio communication network.

Yet another object is to provide a radio base station unit comprising such an apparatus for supporting handover.

These and other objects are met by embodiments as defined by the accompanying patent claims.

In a first aspect, there is provided a method for supporting handover of user equipment from a source cell to a target cell in a radio communication network. The user equipment is assigned dedicated uplink resources in the source cell, and a handover candidate cell is prepared for receiving the user equipment by obtaining information about the assigned dedicated uplink resources in the source cell. A radio base station for the handover candidate cell is listening for user equipment transmissions and determines, when receiving a user equipment transmission, whether the received user equipment transmission can be detected based on information about the assigned dedicated uplink resources in the source cell in order to assess if the received user equipment transmission is coming from user equipment for which the handover candidate cell has been prepared. The radio base station for the handover candidate cell initiates a handover procedure for the user equipment if it is assessed that the received user equipment transmission is coming from user equipment for which the handover candidate cell has been prepared.

In this way, handover can be initiated and completed even if the serving radio base station of the source cell can not receive a handover-triggering measurement report from the UE. Instead, or as a complement, the handover initiation will be performed by a base station of a prepared handover candidate cell.

The initiation of handover may be direct or indirect, and may for example include signaling a handover command directly to the user equipment or signaling to the base station of the currently serving source cell which may take the handover decision.

In a second aspect, there is provided an apparatus for supporting handover of user equipment from a source cell to a target cell in a radio communication network. The user equipment is assigned dedicated uplink resources in the source cell, and a handover candidate cell is prepared for receiving the user equipment by obtaining information about the assigned dedicated uplink resources in the source cell. The apparatus basically comprises a controller and a handover initiating unit. The controller is configured for determining whether a user equipment transmission received in the handover candidate cell can be detected based on information about the assigned dedicated uplink resources in the source cell in order to assess if the received user equipment transmission is coming from user equipment for which the handover candidate cell has been prepared. The handover initiating unit is configured for initiating a handover procedure for the user equipment if it is assessed that the received user equipment transmission is coming from user equipment for which the handover candidate cell has been prepared.

In yet another related aspect, there is provided a radio base station comprising an apparatus for supporting handover.

Other advantages offered by the invention will be appreciated when reading the below description of embodiments of the invention.

### BRIEF DESCRIPTION OF THE DRAWINGS

The invention, together with further objects and advantages thereof, may best be understood by making reference to the following description taken together with the accompanying drawings, in which:

FIG. 1 is a schematic diagram illustrating a simplified overview a radio communication system according to an exemplary embodiment.

FIG. 2 is a schematic flow diagram illustrating a method for supporting handover of user equipment from a source cell to a target cell in a radio communication network according to an exemplary embodiment.

FIG. 3 is a schematic block diagram illustrating an example of a handover support apparatus implemented in a radio base station according to an exemplary embodiment.

FIG. 4 is a schematic diagram illustrating an example of uplink resources assigned for L1/L2 control signaling in a particular radio communication system.

FIG. 5 is a schematic diagram illustrating the signal strengths of two cells in relation to an exemplary handover procedure.

FIG. 6 is a schematic signaling diagram for an exemplary conventional handover procedure.

FIG. 7 is a schematic signaling diagram for an exemplary handover procedure according to an exemplary embodiment.

FIG. 8 is a schematic signaling diagram for an exemplary handover procedure according to another exemplary embodiment.

### DETAILED DESCRIPTION

Throughout the drawings, the same reference numbers are used for similar or corresponding elements.

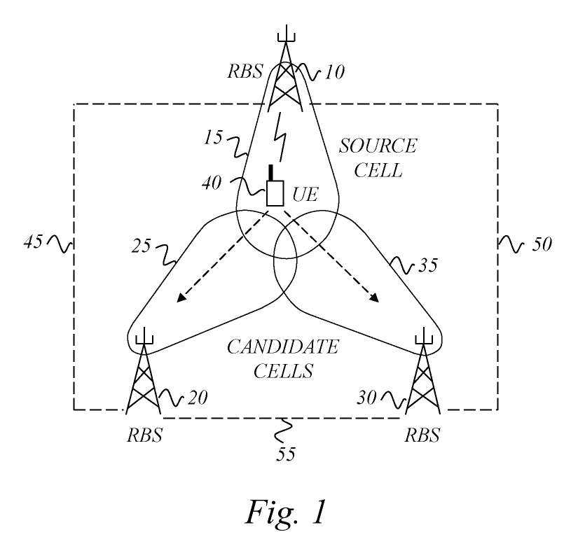

For a better understanding it may be useful to begin with a brief overview of an exemplary radio communication network with reference to FIG. 1.

The simplified radio communication network of FIG. 1 includes a number of radio base stations (RBSs) 10, 20, 30, each of which has the possibility to manage one or more radio cells, for simplicity referred to as cells. For example, radio base station 10 manages one or more cells such as cell 15 that currently serves user equipment (UE) 40. This cell is referred to as a source cell or a serving cell. Radio base station 20 manages one or more cells such as cell 25, and radio base station 30 also manages one or more cells such as cell 35. The cells 25 and 35 are referred to as handover candidate cells for the UE 40, and the UE 40 may be handed over to any of these cells depending on the circumstances and the radio communication conditions in particular. The radio base stations may be directly or indirectly, depending on the radio communication system in question, connected to each other through connections 45, 50, and 55, respectively.

The invention effectively supports handover from a source cell to a target cell in a radio communication network. The user equipment 40 is assigned dedicated uplink resources for shorter or longer periods in the source cell 15, and a handover candidate cell such as cell 25 and/or cell 35 is prepared for receiving the user equipment 40 by obtaining information about the assigned dedicated uplink resources in the source cell 15. This means that the handover candidate cell is provided with information about the assigned dedicated uplink resources so it is possible also for the handover candidate cell to receive and evaluate transmission from the UE on the dedicated uplink resources.

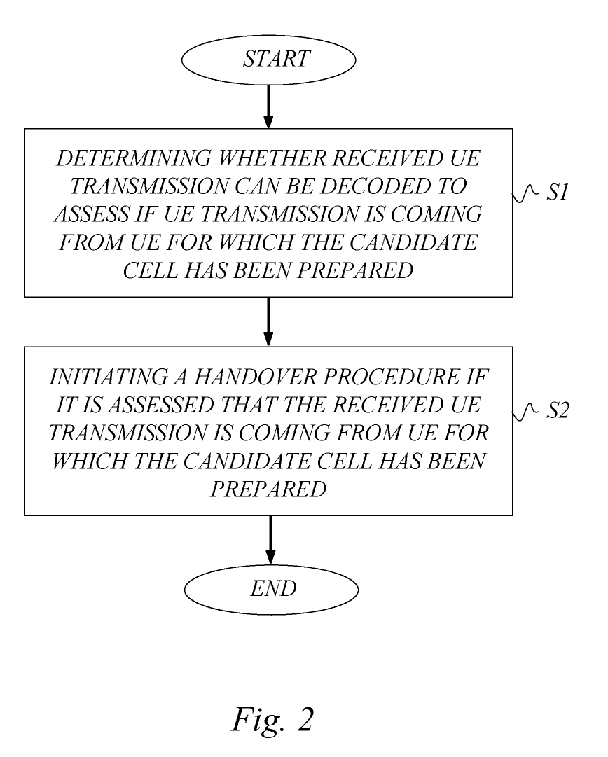

With reference to the schematic flow diagram of FIG. 2, a radio base station such as base station 20 and/or 30 for a handover candidate cell such as cell 25 and /or 35 is listening for user equipment transmissions (indicated by dashed lines in FIG. 1) and determines or evaluates, when receiving a user equipment transmission, whether the received user equipment transmission can be detected based on information about the assigned dedicated uplink resources in the source cell. The information about the assigned dedicated uplink resources indicates on which resources the base station of the handover candidate cell should listen so that the content received on these resources can be analyzed or evaluated. The evaluation assesses if the received user equipment transmission is coming from user equipment for which the handover candidate cell has been prepared (S1), and optionally also assesses the quality of the received transmission. The radio base station for the handover candidate cell then initiates a handover procedure for the user equipment if it is assessed that the received user equipment transmission is coming from user equipment for which the handover candidate cell has been prepared (S2) and has sufficient quality.

In this way, handover can be initiated and completed even if the serving radio base station such as base station 15 of the source cell can not receive a handover-triggering measurement report from the UE.

The term “detect” should be interpreted quite broadly and may encompass the action of detecting and/or decoding. Detecting usually implies detection of a signal or message such as detecting the existence of a given signal/message or type of signal/message. Decoding usually implies decoding some information and may for example include checking CRC and/or decoding some other information entity. It may optionally also involve evaluation of the signal quality of the received transmission to explicitly ensure that the received transmission has sufficient quality, typically above a defined threshold value.

The invention is particularly useful in LTE and LTE Advanced. For example, the radio communication system may be an LTE system, and the handover candidate cell(s) is/are then prepared based on LTE cell preparation.

In LTE, for example, the radio access network (RAN) generally has a single fundamental type of node, namely the Radio Base Station, called eNodeB. The radio access network also has an associated Operations Support System (OSS). Each eNodeB is in charge of a set of one or more cells. The cells of an eNodeB do not have to be using the same antenna site but can have separate dedicated antenna sites.

The eNodeB is normally in charge of a number of functionalities, including single cell radio resource management (RRM) decisions, handover decisions, scheduling of user equipment in both uplink and downlink in its cells.

The known X2 interface connects any eNodeB in the radio communication network with any other eNodeB. This X2 interface is mainly used to support active-mode mobility but may also be used for multi-cell RRM functions. Another interface, the known S1 interface, connects the eNodeB to the core network.

The core network (CN) for LTE is often denoted Evolved Packet Core (EPC) to indicate that it is an evolution from the GSM/General Packet Radio Service (GPRS) core network. The EPC is developed as a single-node architecture with all its functions in one node, the Mobility Management Entity (MME), except the Home Subscriber Server (HSS) (not shown) that is a node or database containing details of each user equipment subscriber that is authorized to use the LTE core network and the user plane gateways (not shown). The EPC connects to the LTE Radio Access Network (RAN) via the-above mentioned SI interface, to the Internet (not shown) via the known SGi interface and to the Home Subscriber Server (HSS) (not shown) using the known S6 interface.

Naturally, the invention can also be applied in other similar communication systems in which network-controlled handover decisions are normally based on downlink measurement reports.

In a particular example, the information about the assigned dedicated uplink resources in the source cell used for cell preparation includes information about the Physical Uplink Control Channel (PUCCH). For example, the PUCCH information includes a code assigned to the user equipment for uplink transmission on the PUCCH. Preferably, the PUCCH information is associated with the user equipment and the source cell through a user equipment identity and a source cell identity, respectively.

As mentioned, the initiation of handover may be direct or indirect, and may for example include signaling a handover command directly to the user equipment 40 or signaling to the base station 10 of the currently serving source cell 15 which may take the handover decision.

For example, a radio base station 20/30 for a handover candidate cell 25/35 may initiate a handover procedure by signaling information to the radio base station 10 for the source cell indicating that the radio base station 20/30 for the handover candidate cell 25/35 has received a user equipment transmission from user equipment for which the handover candidate cell has been prepared. The signaling may be in the form of a handover acknowledgement to the currently serving radio base station 10, as will be exemplified in greater detail later on. The serving radio base station for the source cell 15 may then take a handover decision based on the handover acknowledgment.

To provide for a robust handover mechanism it may be beneficial to let the radio base station 10 for the source cell 15 react and send a handover command to the UE 40 when it has received a predetermined number of handover acknowledgements from the candidate handover cell during a predefined time period. For example, the currently serving radio base station 10 for the source cell 15 may be configured to send a handover command to the UE 40 provided that it receives a first handover acknowledgment in connection with the handover candidate cell being prepared for receiving the user equipment and a second handover acknowledgement indicating that the radio base station 20/30 for the handover candidate cell 25/35 has received a user equipment transmission from user equipment 40 for which the handover candidate cell has been prepared. This means that the source cell is enabled to perform handover without having received a handover measurement report from the considered user equipment.

The radio base station 20/30 for a handover candidate cell 25/35 may also signal information to the currently serving radio base station 10 indicating which uplink resources should be assigned to the user equipment in the handover candidate cell. This means that this information can be transmitted to the UE 40 in connection with the handover command from the radio base station 10 of the source cell.

It may even be possible for a base station 20/30 of a handover candidate cell 25/35 to send detected/decoded information from a UE transmission to the currently serving radio base station 10 for comparison and evaluation to support the handover decision.

Alternatively, the radio base station 20/30 for the handover candidate cell 25/35 signals a handover command more or less directly to the user equipment 40 and signals a request to a central network unit, such as the MME in an exemplary LTE system, of the radio communication network for requesting an on-going connection of the user equipment to be handled by the handover candidate cell.

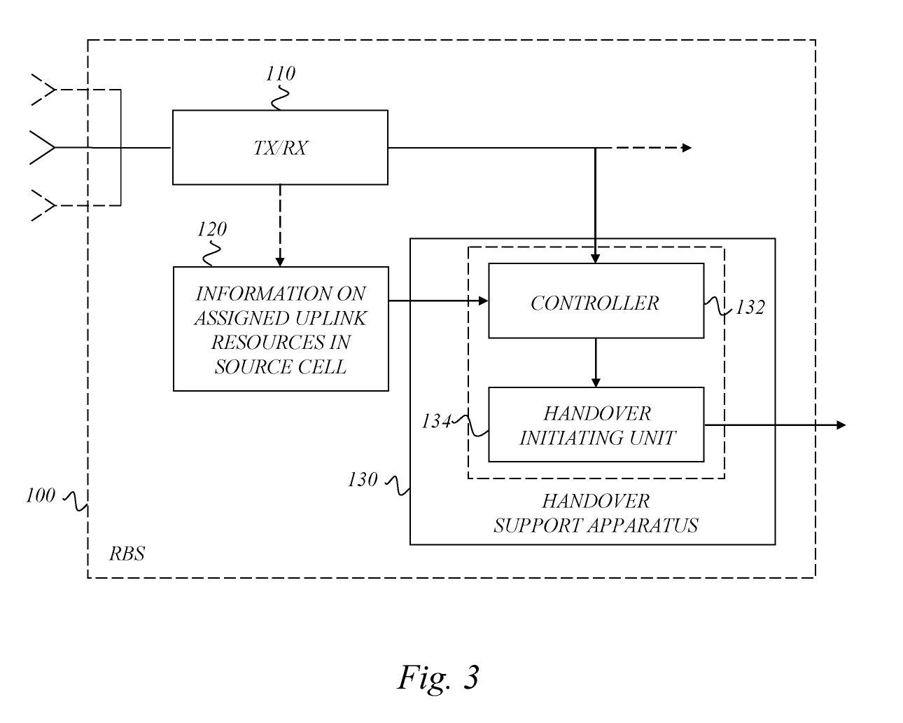

FIG. 3 is a schematic block diagram illustrating an example of a handover support apparatus implemented in a radio base station according to an exemplary embodiment. The overall radio base station 100 includes a conventional antenna arrangement, a standard transmission/reception chain 110, a unit 120 for holding information about assigned uplink resources for user equipment in a source cell, and a handover support apparatus 130. The handover support apparatus 130 basically includes a controller 132 and a handover initiating unit 134. The unit 120 for holding information about assigned uplink resources may be integrated, if desired from an implementation point of view, in the handover support apparatus 130. Similarly, the controller 132 and the handover initiating unit 134 may be integrated in one and the same physical and/or logical module.

In operation, the radio base station 100 is managing one or more cells, at least one of which is a handover candidate cell for user equipment being served by a source cell of another radio base station. The handover candidate cell is prepared for receiving the user equipment based on information about the assigned dedicated uplink resources in the source cell, and this information about assigned uplink resources for the user equipment in the source cell is stored in the unit 120 of the base station 100.

The controller 132 of the handover support apparatus 130 is capable of accessing the information about assigned uplink resources for the user equipment in the source cell from the unit 120, and is configured for determining whether a user equipment transmission received in the handover candidate cell can be detected based on information about the assigned dedicated uplink resources in order to assess if the received user equipment transmission is coming from user equipment for which the handover candidate cell has been prepared.

The handover initiating unit 134 of the handover support apparatus 130 is configured for initiating a handover procedure for the considered user equipment if it is assessed that the received user equipment transmission is coming from user equipment for which the handover candidate cell has been prepared. As previously mentioned the handover initiation may involve signaling a handover command (HO CMD; in 3GPP specifications, for example, the message name is RRC connection reconfiguration) directly to the user equipment or signaling to the base station of the currently serving source cell which may take the handover decision. In the former case, the handover initiating unit 134 also signals a request to a central network unit of the radio communication network for requesting the on-going connection of the user equipment to be handled by the handover candidate cell. In the latter case, information indicating that the radio base station for the handover candidate cell has received a user equipment transmission from user equipment for which the handover candidate cell has been prepared is signaled to the base station of the source cell. This signaling may for example be in the form of a handover acknowledgement (HO ACK) implying that the handover candidate cell is a plausible target cell.

Typically this configuration means that the controller 132 is configured for determining whether a transmission from a UE currently served by another cell can be detected in the handover candidate cell before a decision to handover the user equipment to the handover candidate cell has been taken. For example, the controller 132 may be configured for determining whether a user equipment transmission received in the handover candidate cell can be detected based on information about the Physical Uplink Control Channel (PUCCH). Such information may include a code assigned to the considered user equipment for uplink transmission on the PUCCH.

For example, the base station may be eavesdropping on Scheduling Request (SR), Acknowledgment/Negative Acknowledgment (ACK/NACK) and/or Channel Quality Indicator/Rank Indicator (CQI/RI) messages on the PUCCH.

In the following, the invention will be described with reference to some illustrative examples.

As previously indicated, it is preferred to let prepared cells start searching for UE transmissions and identify, for each considered UE transmission, if the transmission is coming from a UE for which the cell has been prepared. The identification is preferably based on information about the dedicated resources and identities used by the UE and obtained at cell preparation. When a UE transmission is identified as coming from a UE the cell is prepared for, the prepared cell may send information back to the source cell so handover can be initiated. Alternatively, the prepared cell contacts the UE more or less directly.

Preferably, the identification is based on prepared cells receiving the dedicated PUCCH signaling used by the UE in source cell. By way of example, Scheduling Requests (SRs) transmitted from the UE on PUCCH will implicitly disclose the UE identity and source cell.

As an option a quality threshold for the identified UE transmission can be used before sending information back to the source cell.

For a better understanding, more information about PUCCH and handover in LTE-based systems will now be described as an illustrative, non-limiting example, based on SR identification on PUCCH.

PUCCH Resources

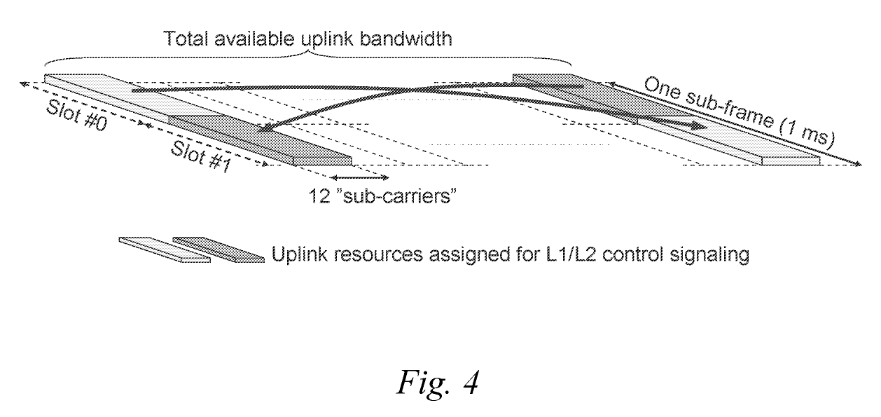

FIG. 4 is a schematic diagram illustrating an example of uplink resources assigned for L1/L2 control signaling in a particular radio communication system.

In general, the bandwidth of one resource block during one sub-frame is too large for the control signaling needs of a single terminal. Therefore, to efficiently exploit the resources set aside for control signaling, multiple terminals can share the same resource block. For example, this is done in Code Division Multiple Access (CDMA) between different terminals where different cyclic shifts of a cell-specific length-12 Constant Amplitude Zero Auto Correlation (CAZAC) sequence are assigned to the terminals. The resource used by a PUCCH is therefore not only specified in the time-frequency domain by the resource-block pair, but also by the cyclic shift (and, for format 0 and 1, additionally by an orthogonal cover). Typically, up to six cyclic shifts can be used in a cell. The length-12 CAZAC sequence is normally generated in the same way as the sequences for uplink reference signals.

PUCCH Format Used for Scheduling Requests

PUCCH format 3 is used for transmitting Scheduling Requests (SRs). The overall structure is similar to that used for hybrid-ARQ acknowledgements and format 3 can thus coexist with another format in the same resource block if needed.

Unlike hybrid-ARQ acknowledgements, the scheduling request does not transmit an explicit information bit. Instead, presence of a PUCCH with format 3 represents a scheduling request. Consequently, if the terminal does not want to be scheduled it does not transmit anything.

Exemplary Handover Procedure

In this particular example, it is assumed that the UE sends a SR on PUCCH before sending a MR when criteria for handover are fulfilled. The SR and MR will be repeated by the UE as long as UE has not received a final handover command. For each UE transmission, each of a number of handover candidate cells will have an opportunity to identify the UE.

If a handover candidate cell identifies the UE, the candidate cell may for example inform the source cell, e.g. over X2 in LTE, that a handover command should be sent to the UE. To minimize signaling and enhance the identification of the fact that the source cell have measurement report reception problems, the candidate cell should receive a scheduling request transmission twice with the expected time in-between requests before informing the source cell.

Alternatively, the candidate cell signals to the source cell for each identified SR. Anyway, the source cell will know that it has failed to receive a MR sent from the UE and that it may schedule the handover command to the UE without actually having received a MR from the UE.

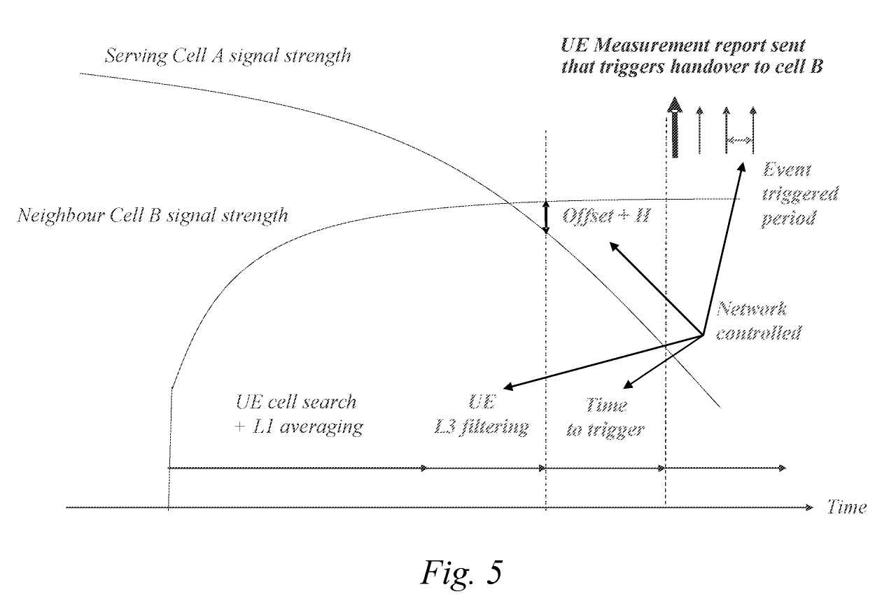

FIG. 5 is a schematic diagram illustrating the signal strengths of two cells in relation to an exemplary handover procedure. In this example, it is assumed that the UE is served by serving cell A, i.e. the source cell, and that a neighbour cell B is a handover candidate cell. When comparing the received signal strengths of these two cells, it can be seen that when the signal strength of the candidate cell becomes better than that of the source cell by a predetermined offset, handover to the candidate cell should be triggered by means of a corresponding measurement report (MR) indicating the improved signal strength in the candidate cell B. However, if the source cell has problems receiving this measurement report, the source cell can not start executing the handover.

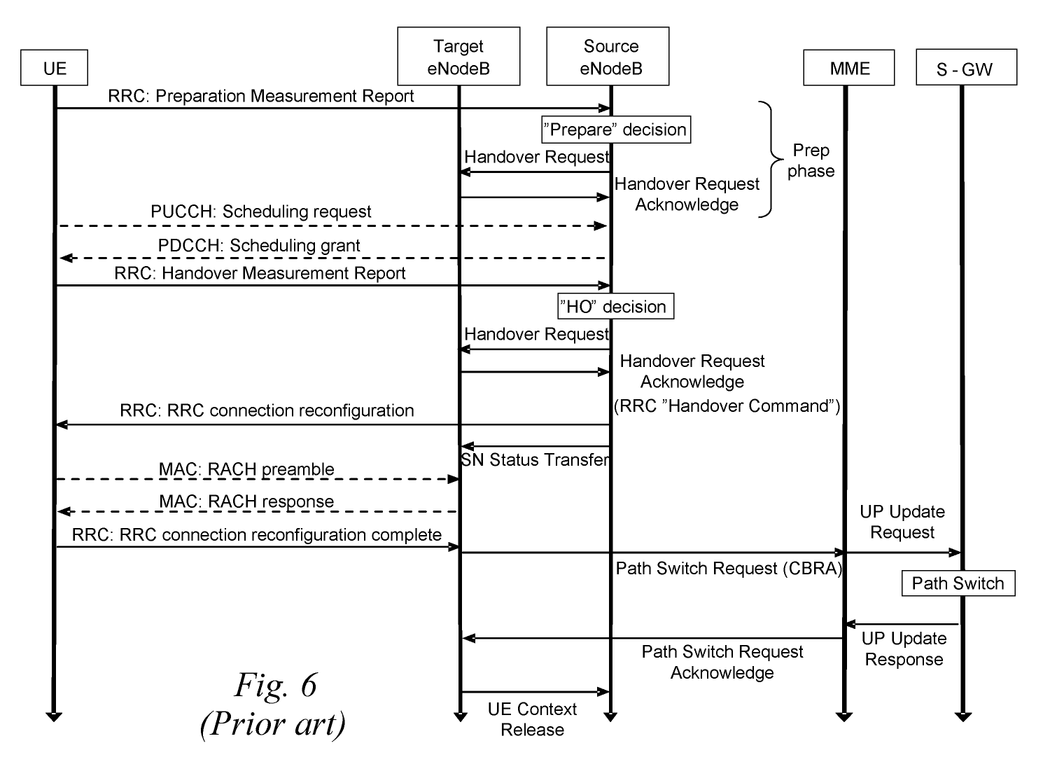

FIG. 6 is a schematic signaling diagram for an exemplary conventional handover procedure. This example basically corresponds to e.g. the standard LTE handover procedure.

Initially, there is a cell preparation phase in which a so-called Preparation Measurement Report is sent from the UE to the source cell. This preliminary measurement report provides an indication as to which preparation cell or cells should be prepared according to a cell preparation procedure. Normally, the source cell takes the so-called “prepare” decision on suitable preparation cells. The cell preparation phase includes transfer of suitable information to the preparation cells, as previously mentioned, and involves a handover request and acknowledgement. The preparation can be triggered by the UE entering the cell via handover or RRC connection establishment or re-establishment and be based on configured information for the Neighbouring cells to prepare.

In response to a scheduling request (SR) and a corresponding scheduling grant the considered UE sends a so-called Handover Measurement Report to the source eNodeB, which takes a real handover decision. A handover request is subsequently sent to the target eNodeB, which takes the required actions for handover and responds by sending a handover request acknowledge back to the source eNodeB.

According to well-accepted handover procedures a Radio Resource Control (RRC) connection reconfiguration message, including the necessary handover parameters, is sent from the source eNodeB to the UE. The UE thus receives the necessary parameters and is commanded by the source eNodeB to perform handover.

The source eNodeB may then send the SN Status Transfer message to the target eNodeB to convey status information depending on RLC mode for the established data radio bearers.

The UE performs synchronization to the target eNodeB and accesses the target cell via RACH (Random Access CHannel), including sending RACH preamble and receiving RACH response. When the UE has successfully accessed the target cell, the UE sends the RRC connection reconfiguration complete message to the target eNodeB to confirm the handover.

The target eNodeB sends a Path Switch Request to the MME to inform the MME that the UE has changed cell, and the MME then sends a User Plane (UP) Update Request to the Serving Gateway (S-GW). The S-GW performs a path switch to switch data to the target side, and sends a UP Update Response to the MME. The MME confirms the path switch by sending a Path Switch Request Acknowledge back to the target eNodeB. The target eNodeB sends a UE Context Release message to the source eNodeB to indicate a successful handover and to trigger release of resources by the source eNodeB.

Note that source eNB can be target eNB and then X2 signalling or S1 signalling is not needed but substituted by internal eNB signaling. If handover is done between cells in the same eNB then path switch request is typically not sent to the CN.

Further information about standard procedures related to handover can be found in the literature, e.g. in reference [1].

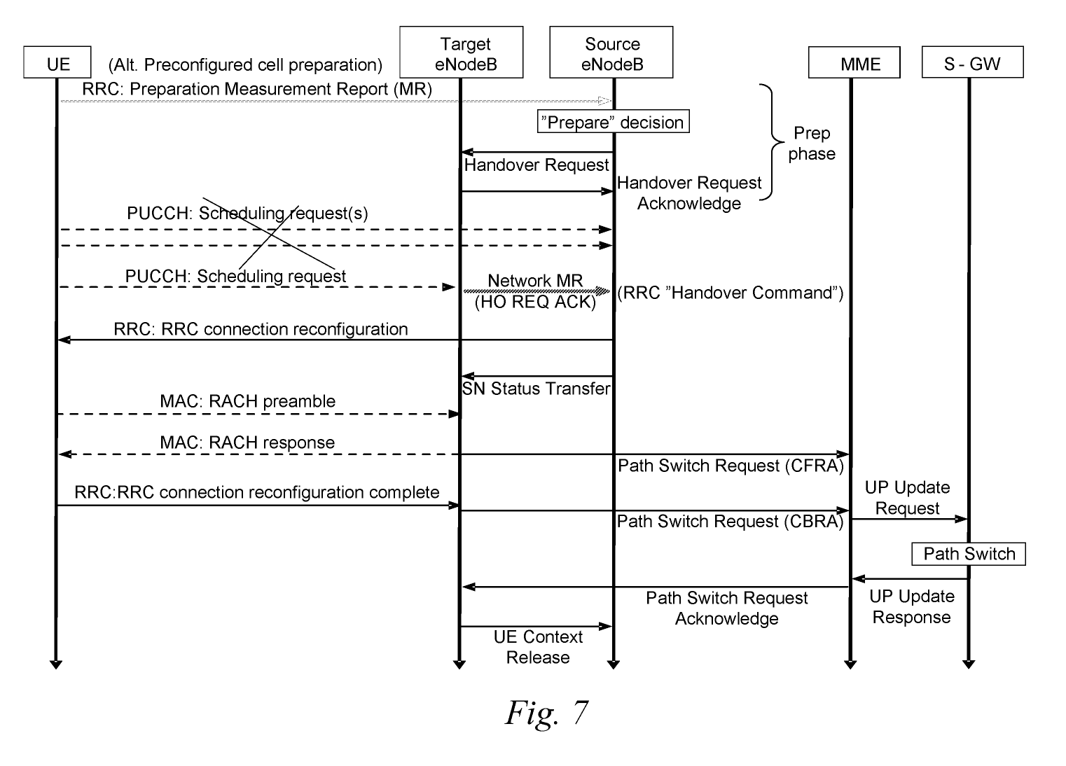

FIG. 7 is a schematic signaling diagram for an exemplary handover procedure according to an exemplary embodiment. This particular example differs substantially from the conventional standard procedure illustrated in FIG. 6 in that handover can be initiated and completed even if the source eNodeB can not receive a handover-triggering measurement report from the UE.

In similarity to the exemplary procedure of FIG. 6, there is a standard cell preparation phase in which the source eNodeB takes a “prepare” decision based on preparation measurement report(s) and provides appropriate cell preparation information to one or more handover candidate cells. Alternatively, the cell preparation does not have to be based on measurement reports (MRs), but may be preconfigured based on more static information such as cell plan information and other similar information.

In this example, it is also assumed that the UE sends a SR on PUCCH before sending a MR when criteria for handover are fulfilled. However, it may be the case that the source eNodeB does not receive the SR(s) and hence not the corresponding measurement report(s). For each such UE transmission, here exemplified by SR transmission by the UE, each of a number of handover candidate cells will have an opportunity to detect the transmission and identify the UE. In the example of FIG. 7, it is assumed that a given so-called target eNodeB detects a PUCCH SR transmission from the UE, and then sends an indication that it has received a UE transmission from a UE for which it has been prepared to the source eNodeB. This is here referred to as a network measurement report (MR) in contrast to the normal standard UE measurement report. The network measurement report may for example be conveyed in a handover request acknowledgment (HO REQ ACK) message.

The source eNodeB may then initiate handover as usual, but without actually having received any UE measurement report. The invention makes handover very robust against uplink problems in the source cell. Further, no changes are needed in existing standards, and the handover support mechanism can be done proprietary if desired.

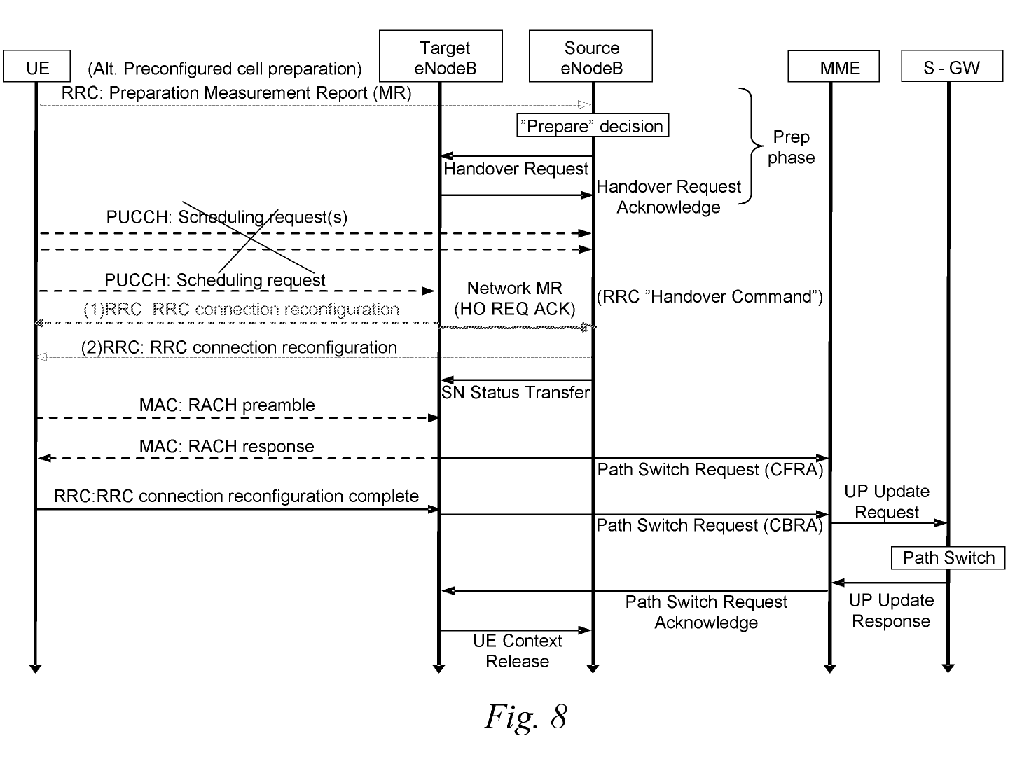

As previously mentioned, the procedure of FIG. 7 is merely an example. Alternatively, the target eNodeB may initiate handover on its own by directly contacting the UE and the MME, as illustrated in FIG. 8. A hybrid implementation, in which both the target eNodeB and the source eNodeB contacts the UE, is also feasible, as indicated as a possible option in FIG. 8.

FIG. 8 is a schematic signaling diagram for an exemplary handover procedure according to another exemplary embodiment. This embodiment is similar to that of FIG. 7, except for the optional possibility to let the target node contact the UE more or less directly by sending a handover command message, e.g. a RRC connection reconfiguration, to the UE. This handover command message, (1)RRC: RRC connection reconfiguration, may be sent as an alternative or as a complement to the handover command message, (2)RRC: RRC connection reconfiguration, sent from the source eNodeB. The handover procedure is then continued as usual, in similarity to FIG. 6 and/or FIG. 7. For the case, when the possibility of sending handover command messages from both the target eNodeB and the source eNodeB are implemented, it must be ensured that the UE can receive and interpret handover command messages from more than one eNodeB. This particular issue may for example be handled in similarity to known WCDMA and HSPA solutions.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A method for supporting handover of user equipment from a source cell to a target cell in a radio communication network, wherein said user equipment is assigned dedicated uplink resources in said source cell, and a handover candidate cell being prepared for receiving said user equipment by obtaining information about the assigned dedicated uplink resources in said source cell, said method comprising the steps of:
a radio base station for said handover candidate cell listening for user equipment transmissions and determining, when receiving a user equipment transmission, whether the received user equipment transmission can be detected based on information about the assigned dedicated uplink resources in said source cell in order to assess if the received user equipment transmission is coming from user equipment for which the handover candidate cell has been prepared;
said radio base station for said handover candidate cell initiating a handover procedure for said user equipment if it is assessed that the received user equipment transmission is coming from user equipment for which the handover candidate cell has been prepared.

2. The method of claim 1, wherein said information about the assigned dedicated uplink resources in said source cell includes information about the Physical Uplink Control Channel (PUCCH).

3. The method of claim 2, wherein said information about the Physical Uplink Control Channel (PUCCH) includes a code assigned to said user equipment for uplink transmission on the PUCCH.

4. The method of claim 2, wherein said information about the Physical Uplink Control Channel (PUCCH) is associated with said user equipment and said source cell through a user equipment identity and a source cell identity.

5. The method of claim 1, wherein said step of said radio base station for said handover candidate cell initiating a handover procedure for said user equipment includes the step of said radio base station for said handover candidate cell signaling information to a radio base station for said source cell indicating that said radio base station for said handover candidate cell has received a user equipment transmission from user equipment for which the handover candidate cell has been prepared.

6. The method of claim 5, wherein said step of said radio base station for said handover candidate cell signaling information to a radio base station for said source cell includes the step of signaling a handover acknowledgement to a radio base station for said source cell.

7. The method of claim 6, wherein said radio base station for said source cell takes a handover decision based on said handover acknowledgment.

8. The method of claim 7, wherein said radio base station for said source cell sends a handover command to said user equipment in response to a predetermined number of received handover acknowledgements from said candidate handover cell during a predefined time period.

9. The method of claim 8, wherein said radio base station for said source cell sends a handover command to said user equipment provided that said radio base station for said source cell receives a first handover acknowledgment in connection with the handover candidate cell being prepared for receiving said user equipment and a second handover acknowledgement indicating that said radio base station for said handover candidate cell has received a user equipment transmission from user equipment for which the handover candidate cell has been prepared.

10. The method of claim 5, wherein said step of said radio base station for said handover candidate cell initiating a handover procedure for said user equipment further includes the step of signaling information to a radio base station for said source cell indicating uplink resources to be assigned to said user equipment in said handover candidate cell.

11. The method of claim 5, wherein said source cell is enabled to initiate handover without having received a handover measurement report from said user equipment.

12. The method of claim 1, wherein said step of said radio base station for said handover candidate cell initiating a handover procedure for said user equipment includes the step of said radio base station for said handover candidate cell signaling a handover command to said user equipment and signaling a request to a central network unit of said radio communication network for requesting an on-going connection of said user equipment to be handled by said handover candidate cell.

13. An apparatus for supporting handover of user equipment from a source cell to a target cell in a radio communication network, wherein said user equipment is assigned dedicated uplink resources in said source cell, and a handover candidate cell being prepared for receiving said user equipment by obtaining information about the assigned dedicated uplink resources in said source cell, said apparatus comprising:
a controller for determining whether a user equipment transmission received in said handover candidate cell can be detected based on information about the assigned dedicated uplink resources in said source cell in order to assess if the received user equipment transmission is coming from user equipment for which the handover candidate cell has been prepared; and
a handover initiating unit for initiating a handover procedure for said user equipment if it is assessed that the received user equipment transmission is coming from user equipment for which the handover candidate cell has been prepared.

14. The apparatus of claim 13, wherein said controller is configured for determining whether a user equipment transmission received in said handover candidate cell can be detected based on information about the Physical Uplink Control Channel (PUCCH).

15. The apparatus of claim 14, wherein said controller is configured for determining whether a user equipment transmission received in said handover candidate cell can be detected based on a code assigned to said user equipment for uplink transmission on the PUCCH.

16. The apparatus of claim 13, wherein said handover initiating unit is configured for signaling information to a radio base station for said source cell indicating that a radio base station for said handover candidate cell has received a user equipment transmission from user equipment for which the handover candidate cell has been prepared.

17. The apparatus of claim 16, wherein said handover initiating unit is configured for signaling a handover acknowledgement to a radio base station for said source cell indicating that said radio base station for said handover candidate cell has received a user equipment transmission from user equipment for which the handover candidate cell has been prepared.

18. The apparatus of claim 13, wherein said controller is configured for determining, before a decision to handover said user equipment to said handover candidate cell has been taken, whether a user equipment transmission received in said handover candidate cell can be detected.

19. The apparatus of claim 13, wherein said handover initiating unit is configured for signaling a handover command to said user equipment and signaling a request to a central network unit of said radio communication network for requesting an on-going connection of said user equipment to be handled by said handover candidate cell.

20. A radio base station for a radio communication network, said radio base station comprising an apparatus according to claim 13.
